(19) United States
(12) Patent Application Publication
(10) Pub. No.: US 2023/0413743 A1
(43) Pub. Date: Dec. 28, 2023

(54) METHOD FOR PRODUCING COATED GROWTH MEDIUM BLOCKS

(71) Applicant: Syngenta Crop Protection AG, Basel (CH)

(72) Inventors: Fernando Lemos Beltrame, Sao Paulo/SP (BR); Adilson Donizeti Correa Da Silva, Sao Paulo/SP (BR); Lothar Otto Erwin Langer, Jr., Sao Paulo (BR); Ronei Ferreira de Menezes, Sao Paulo/SP (BR)

(73) Assignee: Syngenta Crop Protection AG, Basel (CH)

(21) Appl. No.: 18/250,244

(22) PCT Filed: Oct. 22, 2021
(86) PCT No.: PCT/US2021/056139

§ 371 Date: Apr. 24, 2023

Related U.S. Application Data
(60) Provisional application No. 63/107,820, filed on Oct. 30, 2020.

(51) Int. Cl. A01G 24/50; A01G 22/55

(52) U.S. Cl. CPC A01G 24/50; A01G 22/55

(57) ABSTRACT

The present technology relates to coated growth medium blocks for growing of sugarcane plants that include a casing or wrapper and a cavity for receiving the growth medium and for receiving a plant, planting unit or plant part embedded within the growth medium. The casing forms an envelope around each block which includes an individual planting unit embedded within an appropriate growth medium.

### BACKGROUND AND SUMMARY

Sugarcane cultivation is a time and labor intensive procedure. Individual canes have to be cut to smaller-sized cuttings for further propagation. The stem of sugarcane comprises generally several nodes and internodes as in other grasses. At the position of each node, a bud (or “gema”) forms, that can grow to yield the crop. Suitable material for cuttings are pieces of cane cut from 8-14 month old healthy plants, with the older basal buds or buds in the middle to top of the stem germinating stronger and faster. The cuttings are taken from plants which themselves have generally grown from cuttings.

The nodes of sugarcane plants generally range from 10 to 25 cm apart along the above-ground section of the stem. At each node a broad leaf rises which consists of a sheaf or base and the leaf blade. The sheaf is attached to the stem at the node and at that point entirely surrounds the stem with edges overlapping. The sheath from one node encircles the stem up to the next node above and may overlap the base of the leaf on the next higher node. The leaf blade is very long and narrow, varying in width from 2.5 to 7.5 cm and up to 1.5 m or more in length.

In planting sugarcane fields, mature cane stems are cut into sections, either manually in the furrows or by automation and laid horizontally in the furrows. In continental United States, cuttings with several nodes are laid while in tropical countries sections with only 2 or 3 nodes are commonly used since temperatures for growth are more favorable.

The cuttings can be prepared either manually or by mechanical means. Manual preparation involves manually cutting the longer cuttings in the furrow into smaller stem sections having on average three buds, and so a stem section could unintentionally have one bud because of the overlap between the cuttings in the furrow. When mechanical means are used for preparing the cuttings, the stem sections generally have 2 to 3 buds per stem section and these are then placed in the furrows also with aid of mechanical means. Once planted, a stand of cane can be harvested several times; after each harvest, the cane sends up new stems, called ratoons. Usually, each successive harvest gives a smaller yield, and eventually the declining yields justify replanting. Depending on agricultural practice, two to ten harvests may be possible between re-plantings. After planting, the crop is sprayed with water, fertilizer, and pesticides, such as herbicides and insecticides.

These existing agricultural practices with sugarcane illustrate several disadvantages such as the requirement of workmanship to cut the stem, use of different kinds of bulky machines, plurality of steps, and low efficiency. This scenario usually leads to high costs of operation and logistics and undesirable risks for people working in field when cutting the stems. Additionally, one of the greatest disadvantages is that the cutting is cut in a long length, especially when automated, in the range of 40 cm, in order to ensure that there will be at least two or three buds (or also known as “gemas”) per part of cutting, which requires large areas for processing and incurs high costs. Once cut, the larger stem sections require big areas to stock, further increasing costs for the process. Also, the planting of the known stem sections requires a high weight of stem sections per hectare, such as 16-18 ton/ha (by mechanic planting) or 10-16 ton/ha (by conventional planting). There is a need for developing methods of sugarcane cultivation that are simpler, more amenable to automation, less cost prohibitive, and less labor intense.

The present invention relates to coated growth medium blocks, primarily small sized blocks of growth medium, for the growing of sugarcane plants. The blocks may include a casing or wrapper that defines a top and bottom of the block, and a cavity for receiving the growth medium (herein also referred to as the substrate) and for further receiving a plant (or planting unit or plant part, such as plant seed) that is embedded within the growth medium. The casing forms an envelope around each block which includes an individual planting unit embedded within an appropriate growth medium. In some embodiments, the top and bottom ends of the block are open and not covered by the casing. In other embodiments, one or both of the top and bottom of each block is sealed. The casing is composed of a biodegradable material, such as paper (or any biodegradable material that printed into/as a film or paper-like sheet) and is configured to be rigid enough to self-support the individual block structure but also flexible enough to accommodate the volume of growth medium and any plant parts embedded therein. The casing is configured to be breathable, or air-permeable, allowing for flow of air into the plant embedded inside the medium during storage and transport. The breathable casing also allows for the unobstructed flow of air and water between the growth medium and the environment when the planting unit is sowed, thereby promoting plant growth when the block is planted. In one example, the growth medium block includes substrate for the growing of a young sugarcane plant, and includes a sugarcane plant cutting embedded within the substrate.

In some embodiments, an additional coating, such as a coating of a biodegradable polymer with hydrophobic properties (e.g., a wax coating), is provided external to the casing. The external coating at least partially covers the casing and is non-uniform in thickness over the surface of the casing. The coating adds integrity to the block reducing damage to the internal contents during transportation. Further, the coating is configured to limit exposure of the inner block to external environmental elements, thereby reducing water loss from the block during storage, handling, and transportation while still maintaining “breathability” for the plant/cutting. In addition, the external coating protects the plant embedded inside the block from dehydration.

In some embodiments, an additional coating, such as a coating of a biodegradable polymer with hydrophilic properties (e.g., a gel coating), is provided external to the casing. The external coating at least partially covers the casing and is non-uniform in thickness over the surface of the casing. The coating also adds integrity to the block reducing damage to the internal contents during transportation. Further, the coating is configured to limit exposure of the inner block to external environmental elements, thereby reducing water loss from the block during storage, handling, transportation and still being breathable. In addition, the external coating also protects the plant embedded inside the block from dehydration.

The present invention also pertains to methods of making and manufacturing the above-described coated growth medium blocks. Such blocks can be manufactured by various techniques including but not limited to extrusion, compression, or compaction. In one example, the growth medium blocks are configured as cylindrical blocks with open top and bottom ends produced by extrusion of a substrate string that is introduced into a casing tube and cut into pieces of suitable length. In another example, the growth medium blocks are configured as sausage-shaped blocks that are produced by extrusion or compaction and then sealed (e.g., twist sealed, pinched, or cinched) at the top and bottom ends.

In still another example, the growth medium blocks are configured as pouches that are sealed (e.g., crimped or folded) at the top and bottom ends. The pouches are produced by feeding a sheet of material (herein also referred to as a web) along a feed path, dispensing the growth medium onto the web, and then folding the web into a tubular, rectangular, or pillow-shaped formation to form a longitudinal seam along overlapping edges of the sheet. The formation is cut into pieces of suitable length and then a transverse seam is formed across both ends of cut formation to enclose the filling material.

In some embodiments of the method of making growth medium blocks, a discrete amount of the growth medium is intermittently dispensed. The discontinuous dispensing of growth medium generates gaps (or transverse filling voids) in the casing string or tubular formation that do not have growth medium. The formation is cut at these gaps and this can serve as the location for providing transverse seams.

Existing machinery may be used in the production of the growth medium blocks, such as those used in the tobacco industry. However, such machines can be expensive, whereby they are entirely out of reach for large gardening enterprises or for only average sized special factories for use in the production of such blocks. Cost reduction may be achieved through the use of machinery operating by axially pressing the substrate material into the casing tube by means of either a conveying worm or a compaction piston. Further still, suction or vacuum based methods may be used to dispense an amount of growth medium onto the casing prior to sealing the casing to form the blocks. For example, suction may be applied on an amount of dispensed loose substrate material to create a plug of compacted substrate material that is layered on the casing to create the block.

The present invention also discloses the use of smaller sized individual sugarcane planting units that are incorporated into the growth medium block. The planting units include sugarcane stem cuttings that are less then 10%, or less than 5%, the size of conventionally used sugarcane stem cuttings. The use of a smaller functional propagating unit allows for reduction in size of individual blocks, increasing portability, and reducing handling costs.

The approach of producing growth medium blocks described herein provides several advantages, particularly in the field of sugarcane cultivation. As one example, the small size of the growth medium block enables the block to be treated as a cultivation unit, akin to a plant seed, or other optimized plant propagating unit. By providing a casing that extends the shelf life of the cultivation unit while also protecting the contents of the unit from physical damage, storage and transportation of the growth medium block is facilitated. Overall, the block is made more amenable to automated cultivation techniques, such as through the use of automated seed planters for planting each growth block.

### BRIEF DESCRIPTION OF THE FIGURES

FIGS. 1-4 illustrate an example embodiment of a method of producing sugar cane growing blocks comprising growth medium and an embedded sugarcane planting unit.

FIG. 5 illustrates a first example embodiment of a growth medium block configured in a cylindrical form.

FIG. 6 illustrates a second example embodiment of a growth medium block configured in a sausage-shaped form.

FIG. 7 illustrates a third example embodiment of a growth medium block configured in a pouch form.

FIGS. 8-10 illustrate the growth medium blocks of FIGS. 7-9, respectively, with an external non-breathable coating.

FIG. 11 illustrates an assembly with discontinuous dispensing of substrate for use in the production of growth medium blocks having sealed ends.

FIG. 12 illustrates an assembly with continuous dispensing of substrate for use in the production of growth medium blocks having open ends.

FIG. 13 illustrates an example enveloped substrate string before individual growth medium blocks are cut therefrom.

FIG. 14 illustrates individual growth medium blocks cut from the enveloped substrate string of FIG. 13.

FIG. 15 illustrates an example enveloped tubular substrate formation before individual growth medium blocks are cut therefrom.

FIG. 16 illustrates individual growth medium pouches created from the enveloped tubular formation of FIG. 15.

FIG. 17 illustrates an example enveloped substrate string comprising serially connected individual growth medium blocks that are sealed at both ends in a sausage-shaped form.

FIG. 18 illustrates an example enveloped substrate string before individual growth medium blocks are cut therefrom.

FIG. 19 illustrates an example method of excising the substrate string of FIG. 18 to create individual blocks that are open at both ends.

FIG. 20 illustrates an example method of excising the substrate string of FIG. 15 to create individual blocks that are crimp-sealed at both ends.

FIG. 21 illustrates an example method of excising the substrate string of FIG. 18 to create individual blocks that are twist-sealed at both ends.

### DETAILED DESCRIPTION

The present invention describes embodiments of a growth medium block, as well as methods of manufacturing such blocks. The block comprises a breathable and biodegradable casing compactly enveloping an amount of growth medium, and further enveloping a plant part (such as a sugarcane cutting) whose growth is initiated in the growth medium of the block when the block is planted. The block further comprises an outer coating provided external to the casing, the coating provided to add further integrity to the block and to reduce water losses from the inner components of the block and preserve the biological potential of the material. In this way, the growth block acts a single plant cultivation unit that can be easily incorporated in automated farming and cultivation procedures and which has a long shelf life.

Before the growth medium blocks and methods of making the blocks are disclosed and described, it is to be understood that this invention is not limited to the particular configurations, process steps, and materials disclosed herein as such configurations, process steps, order of steps, and materials may vary. It is also to be understood that the terminology employed herein is used for the purpose of describing particular embodiments only and is not intended to be limiting since the scope of the present invention will be limited only by the appended claims and equivalents thereof.

The publications and other reference materials referred to herein are hereby incorporated by reference.

It will be noted that, as used in this specification and the appended claims, the singular forms “a,” “an,” and “the” include plural referents unless the context clearly dictates otherwise. Thus, for example, reference to “a growth medium block” includes two or more blocks, reference to “a biodegradable material” includes reference to a mixture of two or more biodegradable materials, and reference to “a plant growth medium” includes reference to a mixture of two or more plant growth media.

Unless defined otherwise, all technical and scientific terms used herein have the same meanings as commonly understood by one of ordinary skill in the art to which this invention belongs.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.” As used herein, “consisting of” and grammatical equivalents thereof exclude any element, step, or ingredient not specified in the claim. As used herein, “consisting essentially of” and grammatical equivalents thereof limit the scope of a claim to the specified materials or steps and those that do not materially affect the basic and novel characteristic or characteristics of the claimed invention.

As used herein, “planting unit”, “plant part”, and “plant” includes a propagule thereof. Thus, reference to a plant container according to the present invention for receiving “a planting unit” includes reference to a seed, a spore, a cutting, and any other part of the vegetative body capable of independent growth if detached from the parent.

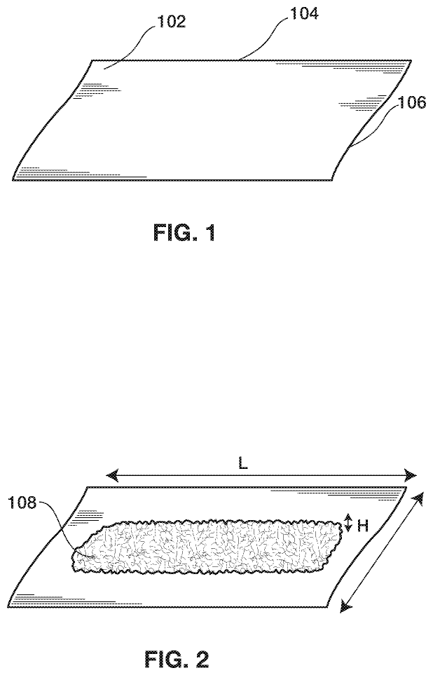

FIGS. 1-4 illustrates a first example embodiment of a method for producing a growth medium block in accordance with the present invention. First, a strip of casing 102 is provided. FIG. 1 shows a strip of casing 102 prior to its being formed into a growth medium block. The strip of casing may be rectangular in shape having a pair of longer longitudinal edges 104 and a pair of shorter terminal edges 106. In the depicted example, a discrete amount of casing is provided, wherein the dispensed amount of casing 102 corresponds to an amount of breathable and biodegradable material, such as paper, that is sufficient for encasing a single growth medium block (herein also referred to as a single unit). However, in other examples, the amount of casing dispensed may be sufficient for the production of a continuous flow production process.

The casing, when rolled, folded, or otherwise molded, defines a cavity, or tubular container, within which growth medium is enclosed to provide the substrate block. The casing provides a level of rigidity to the block and compacts any growth medium enclosed therein. In one non-limiting example, to manufacture a single growth medium block, a strip of casing is dispensed having dimensions between 5 and 10 cm by 5 to 10 cm. Likewise, to manufacture a batch of blocks, a strip of casing is dispensed having dimensions that are an integral multiple of the dimensions of a single unit.

The casing is made of a biodegradable composition that allows for the permeation of air and water there-through. Example biodegradable materials that may be used for the casing include compositions having one or more of the following materials in any combination: cellulosic materials such as paper, polyesters, polylactic acid, vegetable loads such as starches (e.g., cornstarch, rice starch, wheat starch, or the like), flours, and celluloses from a variety of plant sources (such as corn, wheat, rice, barley, oats, or the like), calcium carbonate (CaCO₃), etc.

The composition of the biodegradable material can also include nutrients, pesticides, bio-stimulants, and similar ingredients to stimulate growth and control fungi, insects, nematodes, and other pests or disease agents. In some example usages, after the growth medium block is sowed and upon wetting and degradation of the casing material, these amendments can leach into the growth medium to carry out their beneficial effects.

Any of the biodegradable materials discussed above can be used to produce biodegradable papers or films in accordance with methods well known in the art of paper/film making. The biodegradable paper/film can be used to produce casing strips or a casing web (or roll) for the production of the growth medium blocks of the present invention. The resulting biodegradable papers/films can be printed with indicia of any selected type, such as with decorative indicia, trademarks, product information, watering instructions, and the like. Further, the indicia can include markings delineating casing dimensions for individual growth medium blocks. These may be used by cutting devices as a guidelines to cut the roll into individual units. As described below, the biodegradable papers/films can also be cut, folded, and/or fastened to result in growth medium blocks.

In one example, a single strip of casing corresponding may be cut and dispensed from a storage reel or casing roll or from a larger sheet of biodegradable paper/film (e.g., at a cutting station of an automated growth medium block making equipment/machinery). A continuous web of casing of the biodegradable paper/film, drawn from the roll, may be moving on a first feed path (e.g., on a conveyor belt) along a first, direction and may be acted upon by cutting blades moving at a defined frequency in a second, transverse direction (perpendicular to the first longitudinal direction), wherein the frequency of cutting blade motion is adjusted to generate the desired length of casing strip from the web. In some embodiments, sensors and/or cameras may be operatively coupled to the cutting blades. Upon detection by the camera or sensor of markings on the casing roll (such as indicia printed on the casing that demarcate individual units), the cutting blades may be operated to cut along those markings to provide discrete casing units. It will be appreciated that the strips of casing may alternatively be manually cut. In one example, the single strip of casing may be sized to provide a single growth medium block (that is, a unit). In other examples, the single strip of casing may be sized to correspond to a number of blocks corresponding to one batch of blocks. Herein, a casing string is created. Subsequent processing may be used to cut individual units from the casing string.

In the depicted example, the casing is cut first to create strips, and then the growth medium block is created from the strip. In other example embodiments, a continuous web of casing may be used to first generate a string of growth medium blocks wherein the cutting is performed at a final stage.

Next, at FIG. 2, an amount of growth medium 108 is dispensed onto the casing 102 (e.g., at a dispensing station of an automated growth medium block making equipment/machinery). As used herein, the growth medium (also commonly referred to by the terms “planting medium”, “growing medium”, or “substrate”) refers to a material in which a plant (or plant propagule) is sown to grow a plant. Planting media are well known in the art and the composition of such media are well known and commonly modified or adapted to the grower's needs, the local environment, as well as any specific growth requirements of the corresponding plant. One example growth medium that is commonly used is common soil, which itself varies by geographic region and may or may not be modified dependent on need. There are many different ingredients that can be used to make a growth medium, and different parts of the world have developed media based on local availability of various raw materials. Accordingly, growth media may include compositions including one or more of inorganic materials (e.g. rockwool, perlite, sand, etc.) and organic materials (such as peat, bark, turf and other organic substrates). The composition of the growth medium is selected to generally provide anchorage for the plant that is sowed therein, provide adequate air spaces for root respiration; and hold sufficient available water; hold sufficient available nutrients. Further, the growth medium may be configured to be free of plant pathogens, pests and weeds; and to be safe when handled by people. Growth media is generally physically and chemically stable from the time of production until the time of use. The bulk density of the ingredients used in the composition of a given growth medium may also be carefully selected as this affects transport costs, a major part of the total cost of production and delivery of growth blocks to the end customer. In one embodiment, the growth medium is adapted for the growth of sugarcane.

In some embodiments, the growth media may also be treated with crop protection chemicals, for example, with fungicides, insecticides and nematicides in order to provide plant protection against diseases, insects, fungus and nematodes. Crop protection chemicals are known in the art and include, for example and among others, insecticides, nematicides, fungicides, plant growth regulators, acaricides, microorganisms, bactericides and plant activators. Lists of such agricultural chemicals can be found at Alan Wood's website, <www.alanwood.net/pesticides>, and/or in Tomlin, CDS, ed. (2009), and/or The Pesticide Manual, 15^{th} Edition, British Crop Protection Counsel, (ISBN: 9781901396188).

The term “pesticide” as used herein is intended to cover compounds active against pests which are intended to repel, kill, or control any species designated a pest including weeds, insects, rodents, fungi, bacteria, virus, nematode or other organisms. Examples of pesticides include those selected from, for example and not for limitation, insecticides, acaricides, bactericides, fungicides, nematicides and molluscicides.

Suitable additions of fungicidally active ingredients are, for example and not for limitation, representatives of the following classes of active ingredients: strobilurins, triazoles, ortho-cyclopropyl-carboxanilide derivatives, phenylpyrroles, and other systemic fungicides. In one embodiment the crop protection chemical is a strobilurin fungicide such as azoxystrobin, trifloxystrobin, pyraclostrobin, picoxystrobin or fluoxastrobin. In another embodiment the crop protection chemical is a fungicide such as difenoconazole, fludioxonil, thiabendazole, tebuconazole, metalaxyl, mefenoxam, myclobutanil, sedaxane, boscalid, bixafen, or penflufen.

Suitable additions of insecticidally, acaricidally, nematicidally, or molluscicidally active ingredients are, for example and not for limitation, representatives of the following classes of active ingredients: organophosphorus compounds, nitrophenols and derivatives, formamidines, triazine derivatives, nitroenamine derivatives, nitro- and cyanoguanidine derivatives, ureas, benzoylureas, carbamates, pyrethroids, chlorinated hydrocarbons and Bacillus thuringiensis products. In one embodiment the crop protection chemical is a neonicotinoid insecticide such as thiamethoxam, clothianidin, imidacloprid or thiacloprid. In another embodiment the crop protection chemical is an insecticide such as abamectin, acetamiprid, thiodicarb, nitenpyram, dinotefuran, fipronil, lufenuron, pyriproxyfen, fluxofenim, chlorantraniliprole, cyantraniliprole, beta-cyfluthrin, lambda-cyhalothrin, fenoxycarb, diafenthiuron, pymetrozine, diazinon, disulphate, profenofos, furathiocarb, cyromazine, cypermethrin, tau-fluvalinate, tefluthrin or Bacillus thuringiensis products.

Agricultural chemicals may also include herbicidal safeners. Suitable safeners can be benoxacor, cloquintocet-mexyl, cyometrinil, cyprosulfamide, dichlormid, dicyclonon, dietholate, fenchlorazole-ethyl, fenclorim, flurazole, fluxofenim, furilazole and the corresponding R isomer, isoxadifen-ethyl, jiecaowan, jiecaoxi, mefenpyr-diethyl, mephenate, naphthalic anhydride, oxabetrinil, TI-35, and 2-methoxy-N-[[4-[[(methylamino)carbonyl]amino]phenyl]sulfonyl]-benzamide.

The safeners of the compound of formula I may also be in the form of esters or salts, as mentioned e.g. in The e-Pesticide Manual, version 5.2 (BCPC), 2011. The reference to cloquintocet-mexyl also applies to cloquintocet, and the reference to fenchlorazole-ethyl also applies to fenchlorazole, etc.

Example of microorganisms include those, such as, mycorrhiza, Rhizobia, Bacillus spp., Trichoderma spp., and Pasteuria spp.

Suitable bactericides include, but are not limited to, amicarthiazol, bismerthiazol, bronopol, cellocidin, chloramphenicol, copper ammonium carbonate, copper hydroxide, copper octanoate, copper oxychloride, copper oxides, copper sulfate, copper salts of fatty acids, cresol, dichlorophen, dipyrithione, dodicin, ethylicin, fenaminosulf, formaldehyde, hexachlorophene, hydrated lime, hydrargaphen, 8-hydroxyquinoline sulfate, kasugamycin, nitrapyrin, octhilinone, oxolinic acid, oxytetracycline, phenazine oxide, probenazole, saijunmao, saisentong, silver nitrate, calcium oxide, streptomycin, tecloftalam, thiodiazole-copper, thiomersal, xinjunan, and zinc thiazole. A particularly preferred bactericide of the present invention is silver nitrate and calcium oxide.

A predefined discrete amount of growth medium 108 may be dispensed from a growth medium storage container onto the strip of casing 102. The initial growth medium that is dispensed is typically a loose medium which undergoes further compaction when the casing is rolled or folded to create the growth medium block. In one example, growth medium may be provided along a moving feed path (e.g., conveyor belt), running alongside the feed path feeding the casing, and growth medium is dispensed from the growth medium feed path onto the casing on the casing feed path, such as via a dispenser (e.g., funnel, robotic arm, nozzle, etc.). As such, various forms of existing machinery maybe used for the dispensing. In some examples, suction or vacuum based approaches may be used to dispense the desired amount of growth medium from the growth medium feed path onto the casing prior to sealing the casing to form the blocks. The amount of growth medium dispensed may be based on the nature/composition of the medium, a degree of compaction of the medium, the size of each block, as well as a size of the plant propagule to be accommodated in the block.

In some embodiments, the dispensed growth medium is also compacted upon or during dispensing, such as by axially pressing the growth medium material onto the casing by means of a conveying worm or a compaction piston. In alternate embodiments, as described below, after the casing has been shaped and sealed so as to define a container (e.g., a casing tube or a casing pouch), the growth medium is dispensed and compacted into the container. In still further examples, during the dispensing, loose substrate material may be compacted, such as via vacuum application on a pipe through which the loose material is dispensed, such that a plug of compacted material is extruded onto the casing.

Growth medium may be dispensed to cover the entire length L of the strip (from a top end to a bottom end with no empty space left at either end of the casing) or to cover the entire width W of the strip (from a first longitudinal edge to an opposite longitudinal edge with no empty space left between the edges). Further, growth medium may be dispensed to a height H above the surface of the casing strip. The growth medium is dispensed along a central longitudinal axis (dashed line) of the casing strip, the axis running parallel to the longer edges 102 of the casing strip.

In alternate embodiments, based on the desired final shape of the growth medium block, as well as the method of shaping, it may be necessary to leave one or more filling voids on the casing to allow the casing to be sealed (e.g., via overlap of opposing edges or opposing terminal ends) without the growth medium substantially interfering with the sealing process. For example, as depicted at FIG. 2, growth medium may be dispensed while leaving filling voids at each edge and each end of the casing. Specifically, an amount of space of the casing is left empty at either longitudinal edge, creating longitudinal filling voids where no growth medium is dispensed. These filling voids are provided to allow for overlap and superimposition of the longer edges when the casing is rolled or folded into a final form. Likewise, growth medium may be dispensed while leaving an amount of space at either terminal end of the casing, creating terminal filling voids where no growth medium is dispensed. These filling voids are provided to allow for folding of the shorter edges of the casing to seal the growth medium block at the terminal ends. In some examples, such as where a batch of growth medium blocks is being manufactures, terminal filling voids may be provided at intervals demarcating one block of the batch from a consecutive one. During a later processing step, a casing string may be cut at the terminal filling voids to create individual growth medium blocks.

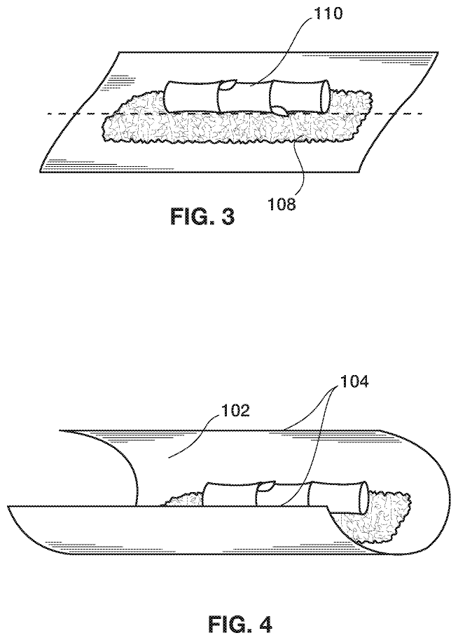

Next, at FIG. 3, a planting unit 110 is layered on top of the dispensed growth medium. In the depicted example, the planting unit is a sugarcane planting unit, particularly a propagule that may be, for example, a single node or mini-cutting of a sugarcane stem (described in further detail below). However, it will be appreciated that other sugarcane plant propagules may be used without departing from the invention and that based on the size of the plant propagule to be layered, the size of the casing strip and the amount of substrate dispensed may be varied.

The planting unit 110 is positioned in the middle of the growth medium, as well as the middle (longitudinally and transversally) of the strip of casing. However, in other examples, the planting unit may be positioned offset towards a particular end of the casing strip, such as to skew the planting unit towards the “top” or “bottom” of the growth medium block.

The planting units may be precut and stored in a condition and controlled environment, and then dispensed, along a dedicated feedpath (e.g., another conveyor belt) onto the layer of growth medium on the casing. In other examples, a plant cutting station is coupled to the feedpath and the planting units are cut in situ prior to the dispensing. It will be appreciated that known dispensing mechanisms, such as robotics arms, nozzles, etc., may be used to dispense the planting unit. Typically, a single planting unit is embedded per growth medium block. However, in some examples, multiple planting units may be provided per growth medium block.

With reference to sugarcane plants the term “internode” is the part of the stalk between two nodes. The term “plant propagation material”, “propagation material”, or “propagule” are plants and parts thereof that are intended for plant cultivation or propagation.

A seed of sugar cane is a dry one-seeded fruit or caryopsis formed from a single carpel, the ovary wall (pericarp) being united with the seed-coat (testa). The seeds are ovate, yellowish brown and very small, about 1 mm long. However, for commercial agriculture, the seed of a sugar cane is not sown or planted, but the cane cuttings (also known as a stem section (or part of a stalk or culm or seedling)) of 40-50 cm in length are placed horizontally in furrows which are generally wide at ground level & deep (40 to 50 cm wide and 30 to 40 cm deep), and then lightly covered with soil. The term “stalk” refers to the portion the sugar cane plant which includes nodes and internodes. The term “node” is the area around the sugar cane bud from the leaf scar to the growth ring and is the part of the stalk from which a leaf, branch, or aerial root grows.

In a more recent technological advance, such as those disclosed in WO2009/000402, WO2013/186558 and WO2019/0182912, the ability to produce single node cuttings and mini-cutting has been disclosed, dramatically reducing the size of sugar cane cuttings. Such single node and mini-cuttings allow the minimum size of sugarcane cuttings that can be used to propagate further plants to be significantly reduced. The small size of these single node and mini-cuttings facilitates the incorporation of these plant propagules inside the small growth medium blocks of the present invention. In addition, the smaller size renders the propagule more amenable to automated handling, and reduces costs associated with transportation, storage, and cultivation.

For single node cuttings that are incorporated within the growth medium block, suitably the stem section comprising the node in accordance with the present invention is from about 2 to about 12 cm in length. More suitably, it is from about 3 to about 8 cm in length, especially from 3.5 to 4.5 cm in length.

For mini-cuttings that are incorporated within the growth medium block, the cutting may comprise one or more nodes, suitably the stem section comprising the node in accordance with the present technology is from about 1 to about 5 cm in length and may have a linear node density (average distribution) of at least 1 node per 3 cm of stalk.

The term “stem cutting” as used herein is used in its conventional sense where a piece of any given parent plant is removed and encouraged to grow as an independent plant by placing the removed plant piece on a suitable growth medium, such as one or more of the following: soil, compost, potting mix, rock wool, perlite, vermiculite, coir, expanded clay pellets, hydrogel and water, which facilitates the growth of new roots and/or stems, which enable the stem cutting to become a plant independent of the source plant. The term “mini stem cutting” as used herein refers to a stem cutting from any given plant species which is about 10% of the size of a typical stem cutting for that plant species, preferably about 5% of the size of a typical stem cutting for that plant species. For example, in the case of sugarcane, a conventional stem cutting is 30 to 40 cm in length, whereas a mini stem cutting from the same sugarcane species may be between 1 and 5 cm in length.

Finally, at FIG. 4, the casing 102 is rolled and sealed to thereby envelop and encase the growth medium substrate 108 and the sugarcane planting unit 110. Specifically, opposing longer edges 104 of the strip of casing are rolled towards each other, with partial overlap, to form a tube. The inner surface of a first longitudinal edge is superimposed over the outer surface of the opposing edge, and the edges are bonded at the region of overlap. Existing machinery and known methods of rolling may be used to create a rolled or fluted structure, such as those used in the tobacco industry. As a non-limiting example, one or more journaled rollers (e.g., cylindrical form rollers) may be coupled to the feedpath carrying the casing with the growth medium and the planting unit. One or more of the rollers may include a groove (e.g., a V-shaped groove) into which the layered casing is received and wherein rotation of the roller results in the creation of the fluted structure. Still other rollers having a central hollow bore into which the casing is received for rolling may be used.

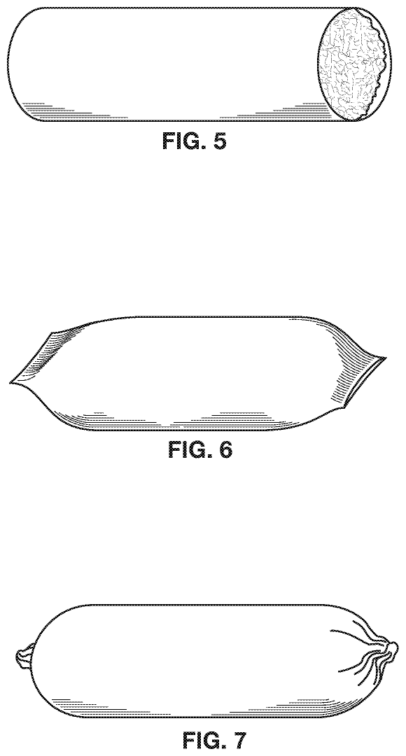

An adhesive material, such as seam glue, is applied on the overlapping section to bond the region of casing overlap at the edges, thereby sealing the tube with the contents therein. Still other known bonding methods may be used to attach the first of the longer edges to the other of the longer edges. In some embodiments, the paper/film may already be impregnated with an adhesive substance to be activated by pressure, another chemical substance, friction, heat or other welding techniques. Any overhanging ends of the casing having no underlying growth medium may be excised. Herein, the resulting growth medium block, shown at FIG. 5, is configured as an open ended tube with the open ends defined by the shorter edges of the casing. However, this configuration and form factor of the growth medium block is not meant to be limiting.

In other embodiments, the method of manufacturing growth medium blocks may be used to create close ended blocks. This may include close ended tubes. For example, with reference to FIG. 4, after rolling and sealing the longer edges of the casing, the shorter edges of the casing may be folded in and sealed to create a closed tube with a smooth surface, akin to a sealed cylinder. In another example, the overhanging shorter ends may be twist sealed to create a sausage-shaped tube, as shown in FIG. 7.

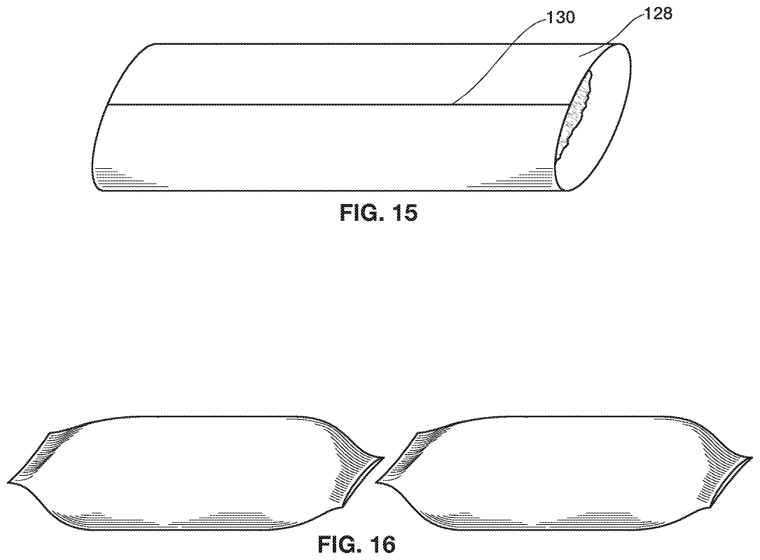

In still another example, instead of rolling the casing strip over the longer edges to create a cylindrical structure, a pouch-like tubular structure may be provided as shown in FIG. 6. Therein, opposing longitudinal edges are folded towards each other, with one edge overlapping the other to create a longitudinal seam of a tubular structure (see, for example, the seam along the casing string in FIG. 15). The shorter edges are then crimp sealed to form a closed pouch enclosing the growth medium and the planting unit.

Alternatively, the tubular pouch structure of FIG. 6 may be formed by folding the casing strip into a tubular form with opposite longitudinal edges in an opposing relation along the tubular form, and then forming a fin seam along the opposing edges of the tubular form. The fin seam is created by the regions of the opposite longitudinal edges having no growth medium therein being juxtaposed next to each other in an opposing relationship. Herein, the inner surface of opposing longitudinal edges having no growth medium are bonded to one another to create the fin seam. This fin seam is then folded into a superposed relation to an outer surface of the tubular form. The fin seam is then sealed to the outer surface of the tubular form to form a combination fin and lap seal. The resulting tubular form is then sealed at the edges via transverse seams to enclose the filling material.

As such, the growth medium blocks of the present technology are not limited to any particular shape or size, but in preferred embodiments may be of a cylindrical shape, square shape, rectangular shape, tubular shape, a pillow or pouch shape (where the casing is pressed together at each end), or sausage shape (where the casing is twisted together at each end). In still further examples, the blocks may be amorphous.

In further embodiments, each substrate block may be molded into a desired final shape, such as by placement of the layered arrangement of the casing strip, growth medium and planting unit onto or inside a mold, or by pressing a molding device onto or over the layered arrangement, thereby shaping the contents into a block.

In still further embodiments, the method allows for providing an additional coating on the growth medium block, the coating applied external to the casing after individual blocks have been generated. The coating may comprise a biodegradable polymer composition. In some examples, the polymer may have either hydrophobic or hydrophilic properties. The coating may at least partially cover the outer surface of the growth medium block or may substantially encapsulate the casing. The coating may be applied non-uniformly such that some regions of the outer surface of the block have a thicker coating than others. In some examples, the non-uniform coating may result in the block being partially coated, with coating provided in some parts of the block and not provided in other parts of the block. That is, there may be regions of the block where the casing is exposed while in other regions of the block, the casing is coated. Coating may be applied by rapidly dipping the substrate in a vat or reservoir containing the biodegradable polymer one or more times. Alternatively, the coating material may be dispensed via a spray nozzle onto the block as it moves on a conveyor belt through a coating station. In another example, the coating can be applied by co-extrusion or by thermally forming the coating around the substrate block. The coating covering the substrate block may be configured to be less than 1 mm (millimetre) thick, preferably less than 0.5 mm thick. In this way, coated substrate blocks can be provided.

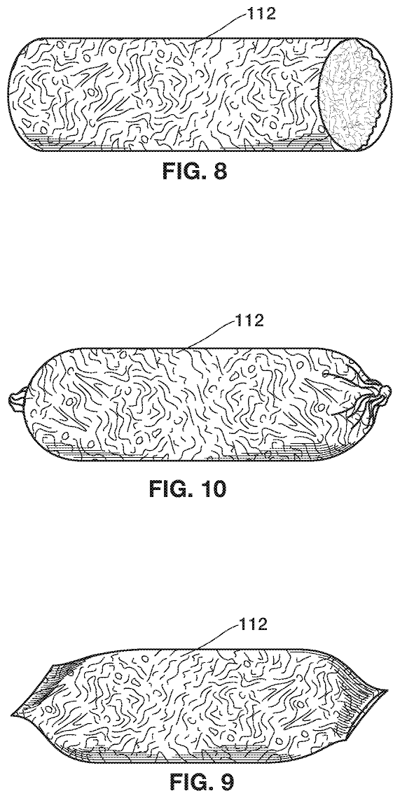

As shown at FIGS. 8-10, coating 112 may be applied to any form or configuration of the growth medium blocks. The coating adds integrity to the block, reducing damage to, and loss of, the internal contents, such as may be incurred during packaging, transportation, or planting of the substrate blocks. The combination of the integrity imparted by the external coating along with the smaller size imparted by the use of a significantly smaller cutting results in a compact substrate block that can be handled using automated farming and cultivation equipment. In one example, where the planting unit is sugarcane, use of the present substrate blocks result in a significant improvement in use of automation during sugarcane cultivation, lowering labor, time and cost requirements.

The coating also limits exposure of the inner substrate block to adverse environmental elements, such as high levels of heat, humidity, or temperature changes, etc., thereby reducing damage to the blocks during storage, handling, and transportation. Consequently, the planting unit embedded inside the block is protected.

The coating material may preferably have a melting point of between 30 to 95° C. As non-limiting examples, the coating material may be a natural or artificial polymer selected from one or more of wax, polyester, petroleum-based paraffin or plastic, polysaccharide or any plant-based plastic.

The coating may also comprise a filler component comprising at least up to 10%, at least up to 20%, at least up to 30%, at least up to 40%, at least up to 50%, at least up to 60%, at least up to 70%, at least up to 80% or at least up to 90% of the coating. The filler may include one or more of the following: (i) fiber from agricultural biomass residue (for example, cereal straw, cotton, peanut hulls, soy straw, corn fodder); (ii) dedicated fibers (for example, Miscanthus, Arundo, sugarcane, bagasse, hemp, Kenaf); (iii) processed fibers (for example, paper, recycled cardboard, wood flour, wood saw dust); and (iv) artificial or processed fibers (for example, nylon, polyester, cotton).

The composition of the external coating can further comprise fungicides, endophytic organisms, plant nutrients, hormones, pesticides, and similar ingredients. Further, the external coating may comprise material such as dyes that allows for easy identification (e.g., to provide a color coding that is indicative of the plant type or growth medium type included in the inner block) and to facilitate sorting (e.g., to facilitate the use of automated sorting equipment). Further still, the external coating may be printed, embossed, or marked with indicia for identification, such as barcodes, decorative indicia, logos, trademarks, product information, watering instructions, and the like. In some examples, the external coating may also comprise transponders or the like to aid in sorting.

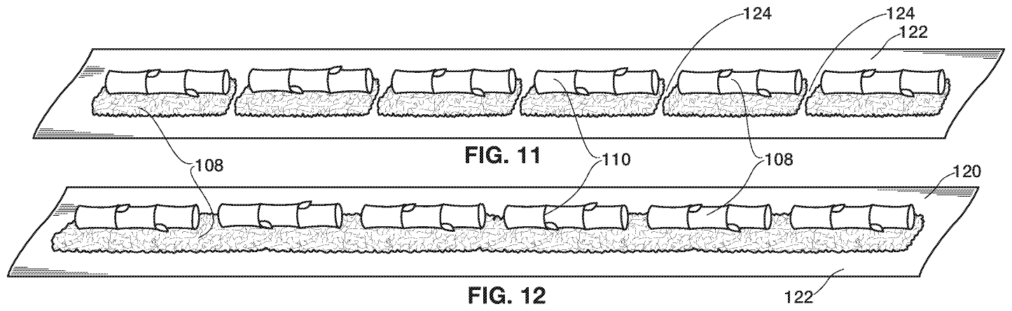

Turning now to FIGS. 11-12, example embodiments of a method of producing substrate blocks is shown. While the embodiment of FIGS. 1-4 show the discontinuous production (also referred to as discrete production or unitary production) of substrate blocks, one at a time, the embodiment of FIGS. 11-12 depict the continuous (or batch-wise) production of blocks, one batch a time.

In both FIGS. 11-12, the method starts with the feeding of a casing web 120 drawn from a storage reel (e.g., a continuous roll of the biodegradable paper which forms the casing) along a first feed path. Concurrently, growth medium 108 is fed along a second feed path, and dispensed onto the casing web. In one embodiment of a system for generating the growth medium blocks, the first feed path comprises a conveyor belt moving the casing web in a first direction. The second feed path includes a conveyor pipe connected to substrate storage container at the inlet end and a dispensing mechanism at the outlet end. The conveyor pipe moves loose substrate medium from the storage container to the dispensing mechanism (such as a funnel or nozzle). The dispenser at the outlet of the second feed path may be positioned vertically above the first feed path to enable the substrate coming out of the conveyor pipe to fall onto the casing web and become layered on a top surface of the casing web. The second feed path may run substantially parallel or perpendicular to the first feed path (or at any other angle), as long as the output is positioned above the first feed path.

The growth medium is dispensed along a central longitudinal axis (dashed lines) of the casing web (running parallel to the longer edges of the casing web). Longitudinal filling voids 122 are provided along the longer edges by adjusting the amount of substrate that is dispensed (and the rate of dispensing) as well as the location of dispensing (e.g., by ensuring that the dispensing is along the central longitudinal axis of the casing web and not offset to any longitudinal edge). In the scenario where there is a continuous production of blocks (FIG. 12), the growth medium is fed without the creation of intermittent transverse filling voids. This includes, in one example, feeding the casing on the first feed path and the growth medium on the second feed path in tandem. The first and second feed paths may be operated at the same speed or at a proportional speed so as to provide a uniform layer of loose substrate material atop the casing web. As discussed earlier, the dispensed substrate material is a loose material that undergoes further compaction when the casing is rolled or folded or otherwise molded to form the blocks (or to form a pre-block structure discussed below). Alternatively, the loose substrate material may be dispensed via a pipe, and a suction device may be used to apply vacuum to the loose substrate, thereby compacting it. A compacted substrate plug is then dispensed from the pipe onto the casing.

In the scenario where there is a discontinuous production of blocks (FIG. 11), the growth medium (loose or compacted) is fed with the creation of intermittent transverse filling voids 124. This includes continuously feeding the casing on the first feed path and intermittently feeding the growth medium on the second feed path. The first and second feed paths may be operated at the same speed or at a proportional speed so as to dispense an amount of substrate corresponding to a single block as a uniform layer of loose substrate material atop the casing web. Then, while the first feed path continues to be operated to dispense the casing web, the dispensing of loose substrate material via the second feed path is temporarily paused to create a filling void. The transverse filling voids demarcate an area at which a cutting operation may be subsequently performed to separate individual growth medium blocks.

In some embodiments, the conveyor pipe of the second path has a suction mechanism (such as a suction funnel, or a dispenser coupled to a vacuum pump) that sucks and dispenses a defined amount of the substrate material. By delivering on a defined amount on each dispensation, while the casing continues to be dispensed, transverse filing voids can be created. In other embodiments, the conveyor pipe of the second pipe has a blowing mechanism (such as an air pump coupled to the dispenser) wherein air pump or blower operation is adjusted (e.g., duration of operation, or pump output) so that a defined amount of substrate is dispensed onto the casing web. A delay is programmable between the sucking or blowing and dispensing of each consecutive amount of substrate material, resulting in the creation of filling voids (e.g., the vacuum pump or air pump is intermittently turned off). In embodiments of the method where the substrate material is layered using suction, it is important that the casing web be made of air permeable material.

Filling voids 124 may also be created by other known mechanical means, such as the use of push pistons or arms or moving baffles that push out a defined amount of substrate material from the second feed path on each piston cycle, operation of a valve at the outlet of the second feed path (e.g., duration and/or degree of valve opening defines amount of substrate dispensed while duration of valve closing defines length of transverse filling voids), operation of a rotatable paddle wheel or auger at the outlet of the second feed path (e.g., number of turns of paddle wheel or auger defines amount of substrate dispensed while length of transverse filling voids are provided when the paddle wheel or auger is not operated), and the like.

In some embodiments, the dispensed substrate material is a loose material that undergoes further compaction when the casing is rolled or folded or otherwise molded to form the blocks (or to form a pre-block structure discussed below).

In both unitary and batch-wise production methods, after layering the substrate material 108 on the casing web 120, planting units 110 are positioned atop the substrate. The planting units (herein depicted as sugarcane propagules in the form of stem mini-cuttings) may be positioned at defined intervals to provide a defined inter-unit spacing. Placement of the planting units may be achieved through the action of robotic arms or other interval-based dispensing mechanisms, similar to those discussed above with reference to discontinuous placement of substrate on the casing web. In some embodiments, where the substrate is placed at intervals on the casing web (FIG. 11), the planting units are fed along a third feed path in concert with the second feed path.

The planting units may be pre-cut units that are stored in a temperature-controlled reservoir. The dispensing device (e.g., robotic arm or nozzle) may dispense a planting unit from the reservoir at intervals. Alternatively, larger sugarcane stems may be stored in a temperature-controller storage tank, and the mini-cuttings are created in situ, by cutting the stem into the mini-cuttings immediately prior to layering the cutting on the substrate.

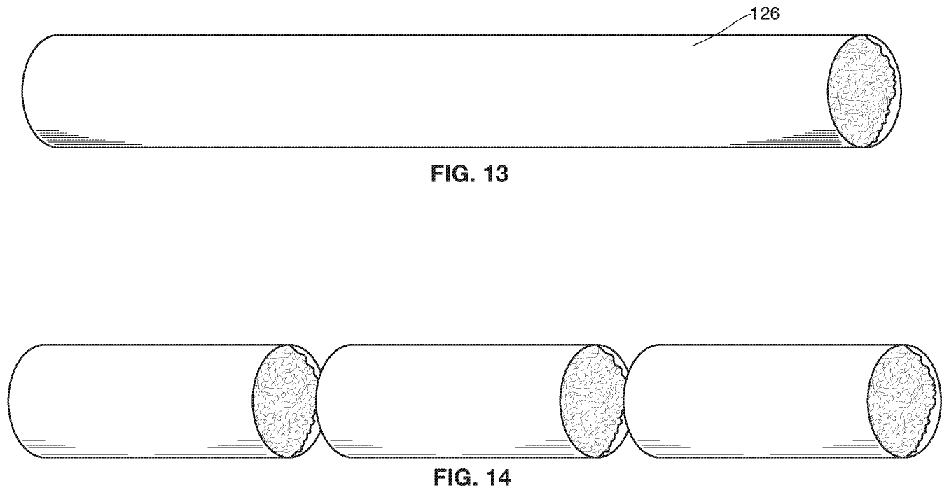

In the next step of the method, longitudinal edges of the casing web are rolled or folded so as to bring the edges in opposition to each other, thereby creating a casing string 126. In the embodiment depicted at FIG. 13, the inner surface of a first longitudinal edge is rolled over the outer surface of the opposite longitudinal edge to create of a casing tube which encloses the growth medium and the planting unit therein.

In other embodiments, as shown in FIG. 15, opposite longitudinal edges may be juxtaposed to create an extended tubular or pouch formation 128. Therein, the inner surface of the longitudinal edges are juxtaposed in an opposing fashion to create a longitudinal fin seam which is then folded and layer over the top surface of the tubular form, thereby creating a fin and lap seal 130 along the longitudinal axis.

In some embodiments, the casing tube or string can be advanced through a vacuum zone, in which air is sucked in or rather out with such a capacity that the suction can be brought to propagate axially through the casing tube. This vacuum action results in compaction of the substrate material. Axial vacuum application is provided on the casing string one or more times until a desired degree of substrate compaction is achieved. For example, the casing tube may be advanced through multiple vacuum zones and/or passed iteratively through the same vacuum zone. A pressure regulator may be provided in the vacuum zone to adjust the vacuum level and thereby vary the degree of compaction and density of the growth medium in the string. The desired degree of compaction may be determined as a function of the nature and quality of the raw substrate material.

The suction method as described above is a well-known method of creating substrate blocks created by the EllePot company and is described in WO92/03914. Still other methods of substrate compaction may be provided such as through the operation of a conveying worm or a compaction piston acting axially on the casing string.

In another embodiment of the technology, the forming of substrate strings can be performed using an extrusion method with an appropriate casing, for example, as generally described in U.S. Pat. No. 3,788,003. In such an approach, compacted substrate growth medium is extruded as a cylindrical body whose curved surface is encased inside a casing material which terminal ends are left open. Individual growth medium blocks may be extruded with casing and then mechanically conveyed to a station for further processing, such as to a coating station for application of an external impermeable coating. Alternatively, substrate strings of a defined length with casing may be extruded, each string then further processed at a cutting station for creation of individual blocks, and then a coating station for application of the external coating. Further still, individual blocks may be directed to a sealing station to seal the terminal ends.

Once the substrate material inside the casing string has been sufficiently compacted (e.g., in the suction zone), the filled casing string may be further advanced by mechanical means, whereby blocks of a suitable length can be cut from the advancing casing string at a cutting station, and these growth medium blocks may then be transferred for subsequent processing (such as for subsequent coating, or terminal end sealing). In some embodiments, the compacted substrate string comprising multiple joined blocks (e.g., 100 or more blocks) is cut into a plurality of intermediate sized strings, each having a smaller number of joined blocks (e.g., 10 or more). Each intermediate string is then automatically mounted in receiver units such as cutting trays for further processing at another section of the cutting station. The intermediate sized strings are then cut into individual growth medium blocks. FIG. 14 shows the creation of individual growth medium blocks, having open terminal ends, from the casing string of FIG. 13 following the action of cutters at a cutting station.

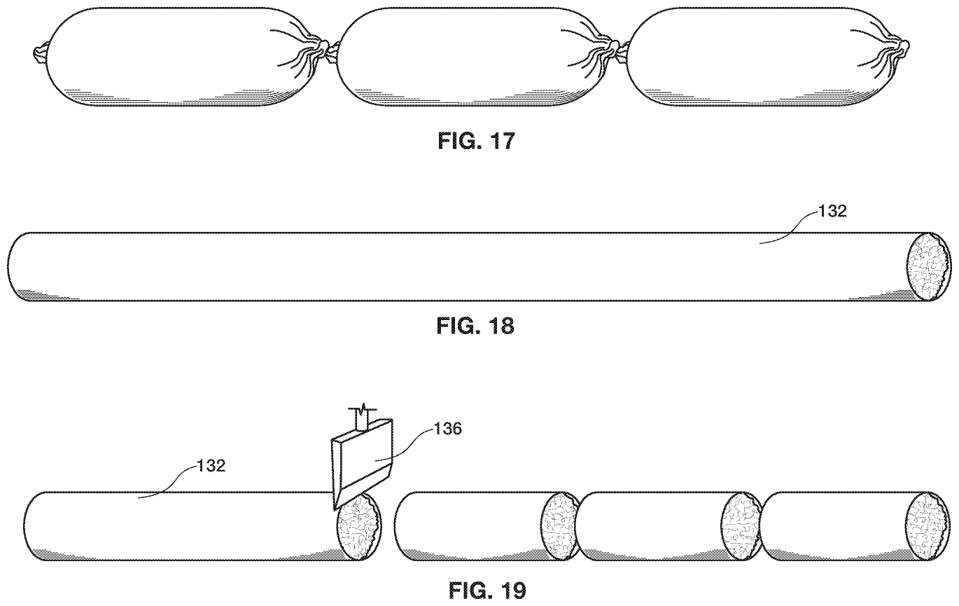

In other embodiments, such as where sealed ends are desired, a cutting station may be configured with cutters, crimpers, or sealers that provide the desired type of sealed ends. As such, sealed ends may only be created from casing strings comprising intermittent transverse filling voids (such as created via the method of FIG. 12). FIG. 17 shows the creation of a sausage-shaped casing string wherein individual blocks have twisted terminal ends.

In one example approach, such a twist may be created by passing the casing string through a conduit that senses the transverse filling void and rotates the string at the filling void location to create the twist. The sausage-shaped casing string can then be directed to a cutting station where cutters can perform a cut separating individual blocks in response to detection of the twist (such as detection via sensors, cameras, etc.). In still other examples the twists may be created at the ends after cutting individual units from the string.

In another embodiment, such as where sealed pouches (FIG. 16) are desired, a tubular casing string (FIG. 15) having transverse filling voids may be directed to a sealing station where a crimping mechanism is configured to provide a crimp (or other sealing stamp) in response to detection of the filling void (such as detection via sensors, cameras, etc.) or based on detection of indicia marked on the casing or coating. The crimping mechanism may include a pair of axially aligned cutting blades positioned above and below a plane of the growth medium block. The cutting blades may have a crimped, wave-like, or undulating shape, wherein the crimp shape is imparted to the casing at the terminal ends of the block upon actuation of the crimped cutting blades towards each other, and towards the block.

The cutting step of the method wherein a casing string is cut to create individual growth medium blocks is now described with reference to FIGS. 18-21.

FIG. 18 shows a casing string unit (more specifically an intermediate sized string 132 derived from a larger continuous casing tube) from which individual growth medium blocks can be derived. After substrate compaction, each casing string unit 132 is conveyed to a cutting station and positioned laterally in front of cutters, such as via a receiving tray or a conveyor belt. In the embodiment shown at FIG. 19, the cutter comprises a convex blade 136 (similar to an axe blade) that is vertically actuated. The cutter is positioned above a plane of the feed path moving the growth medium blocks and downward motion of the convex blade, such as through the action of pulleys, motors, or pumps, results in the clipping of the intermediate sized string into individual growth blocks. In some embodiments, the casing is printed with marking indicia indicative of the relative position of individual blocks. For example, the casing may be printed with marking indicating one or more of the location of the transverse filling voids, the position of the desired terminal ends of each block, the position of the planting unit embedded inside, etc. A sensor or camera operatively coupled to the cutter may enable precise cutting of the string to generate the individual blocks. In other embodiments, the cutting action may be performed using a circular saw, a rapidly reciprocal saw blade, a guillotine blade, or any other blade configured for slicing. Further, the cutting action may involve upward movement of the blade. Further still, the cutting may be performed by a pair of axially aligned blades positioned above and below the plane of the string wherein the blades are vertically actuated towards each other (and towards the string).

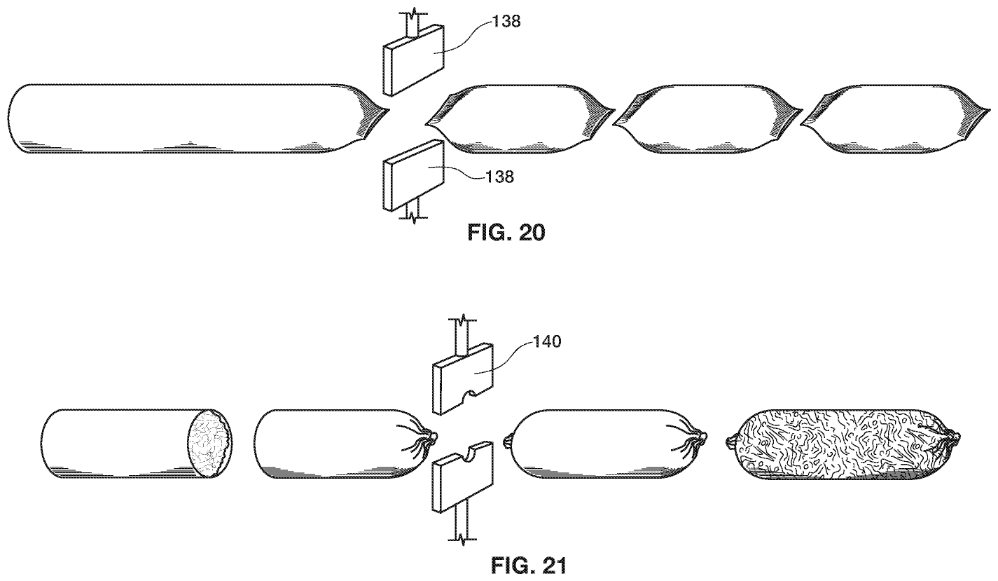

In the embodiment shown at FIG. 20, the cutter comprises a pair of axially aligned crimpers 138 (that is, an upper and a lower crimper aligned along a longitudinal axis which is also the axis of blade motion) that are vertically actuated towards each other. The crimpers may include crimping blades, that is, blades having a wave-like undulating structure. The crimpers are positioned above and below a plane of the string from which individual blocks are cut. Downward motion of the upper crimper and concurrent upward motion of the lower crimper, such as through the action of pulleys, motors, or pumps, results in the cutting of the intermediate sized string into individual growth blocks which are crimp-sealed at the terminal ends. Herein the separation of the string into individual blocks and the sealing of the terminal ends via crimping occurs concurrently and via the same cutting mechanism. In other embodiments, the cutting may be performed separate from the crimping, both temporally (e.g., one action before the other) as well as mechanically (e.g., one device for cutting and a separate device for crimping). In some embodiments, the casing is printed with marking indicia indicative of the relative position of individual blocks. For example, the casing may be printed with marking indicating one or more of the location of the transverse filling voids, the position of the desired terminal ends of each block, the position of the planting unit embedded inside, etc. A sensor or camera operative coupled to the crimpers may enable precise cutting and crimping of the string to generate the individual blocks. In further embodiments, the crimpers may have electrical resistors that allow for thermal crimping.

In the embodiment shown at FIG. 21, the cutter comprises a pair of axially aligned pinchers 140 (that is, an upper and a lower twister aligned along a longitudinal axis which is also the axis of blade motion) that are vertically actuated towards each other. Each twister comprises a rectangular blade with a semicircular cutout along the blade edge. The inner surface of the semicircular cutout is not sharp, does not have a blade, and is not configured to cut. The semicircular regions of the twisters are positioned relative to each other such that when the twisters are actuated towards each other, the semicircular regions are aligned to create a full circle. Downward motion of the upper twister and concurrent upward motion of the lower twister, such as through the action of pulleys, motors, or pumps, results in the cutting of the intermediate sized string into individual growth blocks which are twist-sealed at the terminal ends. Particularly, the rectangular blade edge cuts the casing string to form the individual blocks while the semicircular cutouts, when juxtaposed to form a circular opening, apply a compressing force on the terminal ends of the block (which defines the filling void and has no underlying growth medium). The compressing force resulting in a twist or knot-like structure being formed at the ends.

In other examples, a pair of axially aligned pincher plates positioned above and below the plane of the casing string may be longitudinally advanced towards each other, and then, while remaining coincident, they may be moved transversely or rotated, thereby creating the twisted or pinched structure at the end of the unit. In still further examples, a pair of axially aligned pincher arms may be provided that are configures to pinch the casing while a twisting arm (or roller or gear) rotates the casing string. The pincher arms may be coupled to pincher shafts that are journaled substantially parallel to the axis of rotation of the twisting arm. In some embodiments, the casing is printed with marking indicia indicative of the relative position of individual blocks. For example, the casing may be printed with marking indicating one or more of the location of the transverse filling voids, the position of the desired terminal ends of each block, the position of the planting unit embedded inside, etc. A sensor or camera operative coupled to the twisters may enable precise cutting and twisting of the string to generate the individual blocks.

As described earlier, individual blocks can then be conveyed to a coating station where each block is coated with an impermeable coating. For example, each block may be dipped in a vat containing the coating material. Alternatively, as the blocks move through the coasting station of a conveyor belt, the coating material may be dispensed over them (e.g., via spray coating). Additional crop protection chemicals may be applied to propagation material, to the planting mediums of either of the planting steps describe herein, to the coating, or to the plant itself.

In this way, example methods of making substrate medium blocks are provided. One example embodiment of manufacturing a growth medium block for sugarcane cultivation comprises: dispensing, from a casing roll, a sheet of air-permeable casing onto a first feed-path; dispensing substrate material, drawn from a reservoir, onto the sheet of casing; depositing a sugarcane planting unit on top of the dispensed substrate material, the sugarcane planting unit comprising a mini-stem cutting having less than three nodes; and then superimposing a longitudinal edge of the casing sheet over an opposing longitudinal edge to form a tubular container that defines a cavity enclosing the substrate material and the sugarcane planting unit, the container open at terminal ends, thereby providing the growth medium block. In the preceding embodiment, additionally or optionally, the method further comprises at least partially coating an outer surface of the tubular container with a biodegradable polymer, thereby providing a coated growth medium block. In any or all of the preceding embodiments, additionally or optionally, the method further comprises, prior to dispensing the sheet, cutting the sheet of casing from the casing roll, wherein dimensions of the sheet correspond to a single growth medium block. In any or all of the preceding embodiments, additionally or optionally, the superimposing includes rolling an inner surface of the longitudinal edge over an upper surface of the opposing longitudinal edge to create a longitudinal seam running parallel to a central longitudinal axis of the tubular container. In any or all of the preceding embodiments, additionally or optionally, the method further comprises, bonding the inner surface of the edge to the upper surface of the opposing edge via an adhesive. In any or all of the preceding embodiments, additionally or optionally, the method further comprises, sealing terminal ends of the growth medium blocks via crimp sealing or twist sealing. In any or all of the preceding embodiments, additionally or optionally, the substrate material drawn from the reservoir is loose substrate material, and the method further comprises compacting, via a compacting means, the loose substrate material into a plug of compacted substrate material before depositing the plug of compacted substrate material on the casing.

In any or all of the preceding embodiments, additionally or optionally, the substrate material is dispensed via a pipe, and wherein the compacting means includes one of a suction device configured to apply vacuum on the pipe contents, an extrusion device or conveying worm configured to extrude the compacted plug from the pipe, and a compaction piston configured to apply a compacting force on the loose material before pushing the compacted plug through the pipe. In any or all of the preceding embodiments, additionally or optionally, the dispensed sugarcane planting unit comprises a single node cutting or a mini-stem cutting.

Another example embodiment of a method of manufacturing a growth medium block for sugarcane propagation comprises: dispensing a sheet of air-permeable casing, cut from a casing roll, a size of the sheet corresponding to an integral number of individual growth medium blocks;
dispensing compacted substrate material onto the sheet of casing; depositing, at intervals, a plurality of mini-stem cuttings of sugarcane on top of the dispensed substrate material; rolling a longitudinal edge of the casing sheet over an opposing edge and bonding the edges along a region of overlap to create an open-ended tubular container enclosing the substrate material and the plurality of mini-stem cuttings; cutting the open-ended tubular container into the integral number of individual growth medium blocks; and at least partially coating each individual growth medium block with a biodegradable polymer, thereby creating coated growth medium blocks. In the preceding embodiment, additionally or optionally, the compacted substrate material is dispensed continuously along an entire length of the sheet of casing. In any or all of the preceding embodiments, additionally or optionally, the compacted substrate material comprises a plurality of consecutive plugs of substrate material dispensed intermittently along an entire length of the sheet of casing, thereby including transverse filling voids in between the consecutive plugs. In any or all of the preceding embodiments, additionally or optionally, the dispensed compacted substrate material does not extend along an entire width of the sheet of casing, thereby creating longitudinal filling voids separating the longitudinal edges of the casing from the dispensed substrate material. In any or all of the preceding embodiments, additionally or optionally, the transverse filling voids demarcate a first growth medium from a second, consecutively positioned growth medium block. In any or all of the preceding embodiments, additionally or optionally, a periodicity of the transverse filling voids corresponds to the intervals at which the plurality of mini-stem cuttings are deposited. In any or all of the preceding embodiments, additionally or optionally, depositing the plurality of mini-stem cuttings of sugarcane at the intervals includes depositing a single mini-stem cutting on top of each plug of the substrate material. In any or all of the preceding embodiments, additionally or optionally, the method further comprises, separating, via a cutting means, the tubular container into the individual growth medium blocks, the cutting means actuated along a transverse axis of the tubular container. In any or all of the preceding embodiments, additionally or optionally, the casing is printed with indicia indicative of the individual growth medium blocks, and wherein the cutting means separates the container into the individual growth medium blocks in response to detection of the printed indicia. In any or all of the preceding embodiments, additionally or optionally, the tubular container is substantially cylindrical in shape or pouch-shaped and comprises a longitudinal seam corresponding to the region of overlap between the longitudinal edges. In any or all of the preceding embodiments, additionally or optionally, the method further comprises, sealing, via the cutting means, and concurrently with the cutting, terminal ends of the individual growth medium blocks. In any or all of the preceding embodiments, additionally or optionally, the sealing comprises crimp sealing or twist sealing the terminal ends.

Another example embodiment of a method of making growth medium blocks for sugarcane cultivation comprises, embedding a sugarcane mini-stem cutting within a plug of compressed substrate material, the substrate material encased inside a tubular structure defined by a sheet of air-permeable casing; and at least partially coating an outer surface of the tubular structure with a biodegradable polymer. In the preceding embodiment of the method, the plug of compressed substrate material is encased inside the tubular structure via extrusion of the casing from a casing roll on a first feed path and concurrent extrusion of the plug of compacted substrate material onto the casing, the compacted substrate material compacted from loose substrate material via vacuum application.

An example embodiment of a coated growth medium block, manufactured by any of the above-described methods, comprises: an air-permeable casing defining a tubular structure with an inner cavity and open terminal ends; compacted substrate material housed in the cavity; a planting unit embedded inside the substrate material, substantially along a central axis of the tubular structure, wherein the planting unit can propagate a vegetatively reproducing plant when the block is sown in soil; and a biodegradable polymer coating at least partially covering an outer surface of the casing. In the preceding embodiment of the growth medium block, the planting unit is a sugarcane planting unit comprising a single node cutting from a mature sugarcane stem or a mini-stem cutting having less than three nodes.

The description herein is merely exemplary in nature and, thus, variations that do not depart from the gist of that which is described are intended to be within the scope of the teachings. Such variations are not to be regarded as a departure from the spirit and scope of the teachings. The scope of the invention should be determined by the appended claims and their legal equivalents.

1. A method of manufacturing a growth medium block for sugarcane cultivation, comprising:
dispensing, from a casing roll, a sheet of air-permeable casing onto a first feed-path;
dispensing substrate material, drawn from a reservoir, onto the sheet of casing;
depositing a sugarcane planting unit on top of, of inside, the dispensed substrate material, the sugarcane planting unit comprising a mini-stem cutting having three nodes or less; and
superimposing a longitudinal edge of the casing sheet over an opposing longitudinal edge to form a tubular container that defines a cavity enclosing the substrate material and the sugarcane planting unit, the container open at terminal ends, thereby providing the growth medium block.

2. The method of claim 1, further comprising at least partially coating an outer surface of the tubular container with a biodegradable polymer, thereby providing a coated growth medium block.

3. The method of claim 1, further comprising, prior to dispensing the sheet, cutting the sheet of casing from the casing roll, wherein dimensions of the sheet correspond to a single growth medium block.

4. The method of claim 1, wherein the superimposing includes rolling an inner surface of the longitudinal edge over an upper surface of the opposing longitudinal edge to create a longitudinal seam running parallel to a central longitudinal axis of the tubular container.

5. The method of claim 4, further comprising, bonding the inner surface of the edge to the upper surface of the opposing edge via an adhesive.

6. The method of claim 1, further comprising sealing terminal ends of the growth medium blocks via crimp sealing or twist sealing.

7. The method of claim 1, wherein the substrate material drawn from the reservoir is loose substrate material, the method further comprising, compacting, via a compacting means, the loose substrate material into a plug of compacted substrate material before depositing the plug of compacted substrate material on the casing.

8. (canceled)

9. (canceled)

10. A method of manufacturing a growth medium block for sugarcane propagation, comprising:
dispensing a sheet of air-permeable casing, cut from a casing roll, a size of the sheet corresponding to an integral number of individual growth medium blocks;
dispensing compacted substrate material onto the sheet of casing;
depositing, at intervals, a plurality of mini-stem cuttings of sugarcane on top of the dispensed substrate material;
rolling a longitudinal edge of the casing sheet over an opposing edge and bonding the edges along a region of overlap to create an open-ended tubular container enclosing the substrate material and the plurality of mini-stem cuttings;
cutting the open-ended tubular container into the integral number of individual growth medium blocks; and
at least partially coating each individual growth medium block with a biodegradable polymer, thereby creating coated growth medium blocks.

11. The method of claim 10, wherein the compacted substrate material is dispensed continuously along an entire length of the sheet of casing.

12. The method of claim 10, wherein the compacted substrate material comprises a plurality of consecutive plugs of substrate material dispensed intermittently along an entire length of the sheet of casing, thereby including transverse filling voids in between the consecutive plugs.

13. The method of claim 10, wherein the dispensed compacted substrate material does not extend along an entire width of the sheet of casing, thereby creating longitudinal filling voids separating the longitudinal edges of the casing from the dispensed substrate material.

14. The method of claim 12, wherein the transverse filling voids demarcate a first growth medium from a second, consecutively positioned growth medium block.

15. The method of claim 14, wherein a periodicity of the transverse filling voids corresponds to the intervals at which the plurality of mini-stem cuttings are deposited.

16. The method of claim 14, wherein depositing the plurality of mini-stem cuttings of sugarcane at the intervals includes depositing a single mini-stem cutting on top of each plug of the substrate material.

17. The method of claim 10, further comprising, separating, via a cutting means, the tubular container into the individual growth medium blocks, the cutting means actuated along a transverse axis of the tubular container.

18. The method of claim 17, wherein the casing is printed with indicia indicative of the individual growth medium blocks, and wherein the cutting means separates the container into the individual growth medium blocks in response to detection of the printed indicia.

19. The method of claim 15, wherein the tubular container is substantially cylindrical in shape or pouch-shaped and comprises a longitudinal seam corresponding to the region of overlap between the longitudinal edges.

20. The method of any of claims 17-18, further comprising, sealing, via the cutting means, and concurrently with the cutting, terminal ends of the individual growth medium blocks.

21. (canceled)

22. A coated growth medium block, comprising:
an air-permeable casing defining a tubular structure with an inner cavity and open terminal ends;
compacted substrate material housed in the cavity;
a planting unit embedded inside the substrate material, substantially along a central axis of the tubular structure, wherein the planting unit can propagate a vegetatively reproducing plant when the block is sown in soil; and
a biodegradable polymer coating at least partially covering an outer surface of the casing.

23. The block of claim 22, wherein the planting unit is a sugarcane planting unit comprising a single node cutting from a mature sugarcane stem or a mini-stem cutting having no more than three nodes.

24. (canceled)

25. (canceled)
